(19) United States
(12) Patent Application Publication
(10) Pub. No.: US 2012/0199590 A1
(43) Pub. Date: Aug. 9, 2012

(54) FRONT-LOADING TRASH CONTAINER WITH INTEGRATED REAR TRASH CAN DUMPING MECHANISM

(75) Inventor: Serge THERRIEN, Blainville (CA)

(73) Assignee: LES INDUSTRIES DU MAITRE COMPACTEUR INC., Saint-Eustache (CA)

(21) Appl. No.: 13/022,996

(22) Filed: Feb. 8, 2011

(51) Int. Cl. B65F 1/10; B65F 1/12

(52) U.S. Cl. 220/564; 220/772; 220/908; 414/810

(57) ABSTRACT

The trash container includes a container body including a front wall, a rear wall, a floor, a right side wall, a left side wall and a top section defining together an interior compartment for collecting and containing trash. It also includes a trash can dumping mechanism positioned on the rear wall of the container body. The trash can dumping mechanism is provided to lift and tip a trash can to transfer trash from inside the trash can into the interior compartment of the container body. The fact that the trash can dumping mechanism is position at the rear greatly simplifies the task of emptying trash cans when the service door of a building is closer to the rear side of the trash container than the front side thereof. This feature can save time and efforts, especially in cold and/or bad weather.

### TECHNICAL FIELD

The technical field relates generally to front-loading trash containers to be emptied into dumpsters by lifting and tipping them using actuated forklift arms mounted on the dumpsters.

### BACKGROUND

Trash containers are often provided to collect solid trash from commercial, industrial and even residential users before the trash be loaded into a dumpster. These trash containers generally consist of large rectangular steel boxes located outside the buildings, often in areas such as the back of the buildings or in lanes. A trash container has one or more top access doors for depositing the trash and also for permitting the trash to be emptied using actuated forklift arms mounted on the dumpster and fitting, into corresponding external sleeve members provided on the side walls of the trash container. The forklift arms lift and tip the whole trash container until its content falls by gravity into the dumpster.

There are various kinds of trash containers. Some of them are designed to be emptied by first positioning the front of the dumpster in front of the trash container. Such trash containers are hereby referred to as front-loading trash containers since they are handled using forklift arms located at the front of the dumpsters. A front-loading trash container is emptied by lifting it over the cab of the dumpster and tipping it until their contents fall by gravity therein. Generally, the emptied trash container is then put back to its original location in front of the dumpster. Finally, the dumpster backs off and moves to its next destination.

Other kinds of trash containers exist as well. For instance, some trash containers are deigned to be emptied into the rear side of the dumpsters.

Some models of front-loading trash containers are provided with an integrated trash can dumping mechanism. This dumping mechanism facilitates the transfer of the content of a trash can, which trash can comes from a remote location, into the trash container. The trash can is carried next to the trash container by a person and its content is emptied through a top opening of the trash container by lifting and tipping the trash can using the dumping mechanism. The contents fall by gravity inside the trash container.

Some front-loading containers include a trash can dumping mechanism provided on the front side thereof, i.e. on the same side facing the dumpster when the trash container is emptied. This, however, may create some difficulties when the trash container is located in a relatively tight space where a dumpster cannot maneuver easily, for instance in a narrow lane at the back of a restaurant. Since the front side of the trash container must always remain accessible to the dumpster, it is not always possible to have the trash can dumping mechanism very close to a service door of a building. Even if the trash container is positioned immediately in front of the service door, a person would need to move the trash can all the way around the trash container to reach the dumping mechanism located on the front side. This may be challenging and time consuming in had and/or cold weather. For instance, an employee of a restaurant working during a very cold day needs to put warm clothes on and sometimes must carry the trash can over snow or ice on the ground to reach the trash can dumping mechanism on the front side of the trash container.

Room for improvements thus exists in this area of technology.

### SUMMARY

In one aspect, there is provided a front-loading trash container, the trash container including: a container body having a front wall, a rear wall, a floor, a right side wall, a left side wall and a top section defining together an interior compartment for collecting and containing trash, the top section having a front top opening and a rear top opening; at least one lid for each of the top openings, each lid being operatively connected to the container body; a right and a left external sleeve member rigidly connected to right side wall and the left side wall of the container body, respectively, the right and left external sleeve members being engagable by forklift arms of a dumpster to lift and tilt the trash container until the trash therein falls by gravity through the front top opening and into the dumpster; and a trash can dumping mechanism positioned on the rear wall of the container body, the dumping mechanism lifting and tipping a trash can to transfer trash from inside the trash can into the interior compartment of the container body through the rear top opening.

In another aspect, there is provided a method of handling trash using a trash container, the trash container having a front side and a rear side, the method including: loading at least some of the trash inside the trash container using a trash can dumping mechanism positioned on the rear side of the trash container, the trash inside the trash can entering the trash container through a top opening located on the rear side of the trash container; and emptying the trash container into a front-loading dumpster upon lifting and tipping the trash container over the dumpster until the trash falls by gravity into the dumpster through a top opening located on the front side of the trash container.

Further details on these aspects as well as other aspects of the proposed concept will be apparent from the following detailed description and the appended figures.

### BRIEF DESCRIPTION OF THE FIGURES

FIG. 1 is a front isometric view illustrating an example of a front-loading trash container incorporating the proposed concept; and

FIG. 2 is a rear isometric view of the trash container shown in FIG. 1.

### DETAILED DESCRIPTION

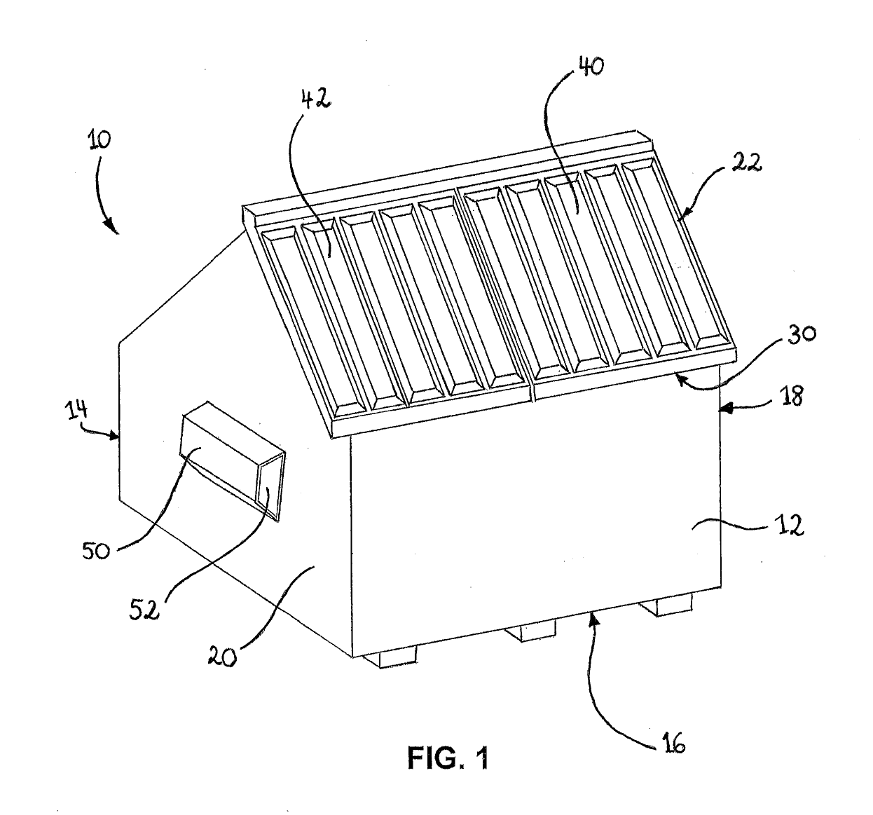

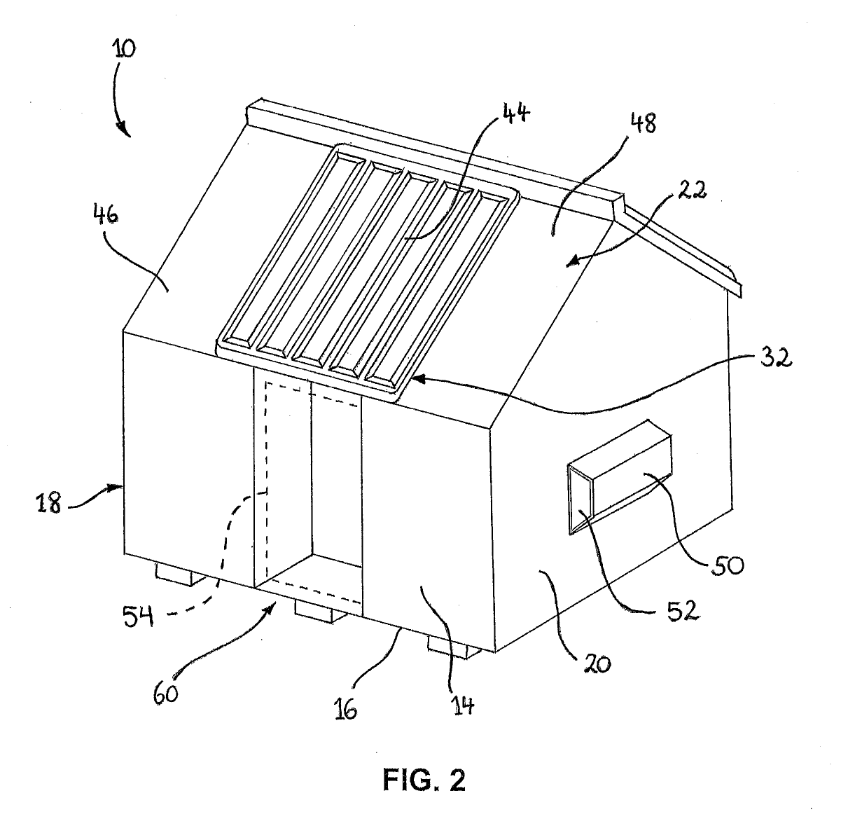

FIG. 1 is a front isometric view illustrating an example of a front-loading trash container 10 incorporating the proposed concept. FIG. 2 is a rear isometric view thereof.

The trash container 10 has a container body. This container body is generally rectangular in shape, as shown. Other shapes and configurations are possible as well. The container body includes a front wall 12, a rear wall 14, a floor 16, a right side wall 18, a left side wall 20 and a top section 22. They define together an interior compartment for collecting and containing trash between two dumpster visits. Depending on the needs, the interior compartment can be subdivided or not.

The various components of the container body can be made of metal, for instance steel. Using other metals or even other materials is also possible. Still, one can use more than one kind of material for constructing the container body.

As shown in the illustrated example, the top section 22 of the container body has a somewhat triangular cross section when viewed from the side. One portion of the top section 22 is oriented towards the front side of the trash container 10 and the other portion is oriented towards the rear side thereof.

The top section 22 has a front top opening 30 and a rear top opening 32. These top openings 30, 32 are delimited by rims that are in provided in inclined planes. The inclination of the plane at the front is opposite the inclination of the one at the rear. Both inclinations, however, do not need to be symmetrical.

At least one lid is provided for each of the top openings 30, 32 and each lid is operatively connected to the container body. In the illustrated example, two rectangular front top lids 40, 42 are provided over the front top opening 30 and one rectangular rear top lid 44 is provided over the rear top opening 32. Both front top lids 40, 42 can be opened individually and can be made of a light material such as plastic. They each extend over one half of the width of the trash container 10. The rear top lid 44 is narrower in width than that of the trash container 10 and is centered. Two side plates 46, 48 are provided to close the areas on both sides of the rear top opening 32.

Also in the illustrated example, the top edge of each of the front top lids 40, 42 is pivotally connected to the container body. The side edge of the rear top lid 44 is pivotally connected to the container body. Variants are possible. For instance, the rear top lid 44 can be slidably connected to the container body. Other variants are possible as well.

A right and a left external sleeve member 50 are rigidly connected to right side wall 18 and the left side wall 20 of the container body, respectively. The right external sleeve member 50 is the mirror image of the left one. Each of these external sleeve members 50 defines a channel 52 through which can be inserted a corresponding one of the actuated forklift arms of a dumpster. The forklift arms engage the channel 52 of the external sleeve members 50 when the dumpster is positioned right in front of the front wall 12 of the trash container 10. Once the forklift arms are in position, the trash container 10 can be lifted and tipped over the dumpster using an actuation mechanism, for instance hydraulic actuators, until the trash therein falls by gravity through the front top opening 30 directly into the bin of the dumpster. The front top lids 40, 42 will pivot by gravity to an open position as the trash container 10 is tipped.

A trash can dumping mechanism is integrated to the rear wall 14 of the container body. The dumping mechanism is provided to lift and tip a trash can so as to transfer trash from inside the trash can into the interior compartment of the container body through the rear top opening 32. The dumping mechanism is schematically illustrated in FIG. 2 using stippled lines at 54. Unlike existing trash containers, this dumping mechanism 54 is positioned on the rear wall 14 of the trash container 10.

As shown in FIG. 2, the rear wall 14 of the container body includes a rectangular recess 60 positioned at the center thereof. The rectangular recess 60 is the location when the various components of the trash can dumping mechanism 54 are provided. The exact construction of the trash can dumping mechanism 54 may vary from one implementation to another, depending on the needs. The rear top lid 44 is manually opened before the dumping mechanism 54 is operated but other arrangements are also possible.

Overall, the proposed concept provides a method of handling trash using a trash container 10, the trash container having a front side and a rear side. The method includes:
loading at least some of the trash inside the trash container 10 using a trash can dumping mechanism positioned on the rear side of the trash container 10, the trash inside the trash can entering the trash container 10 through a top opening 32 located on the rear side of the trash container 10; and
emptying the trash container 10 into a front-loading dumpster upon lifting and tipping the trash container 10 over the dumpster until the trash falls by gravity into the dumpster through a top opening 30 located on the front side of the trash container 10.

As can be appreciated, providing the trash can dumping mechanism on the rear side of the front-loading trash container 10 greatly simplifies the task of emptying trash cans when the service door of a building is closer to the rear side of the trash container 10 than the front side thereof. This feature can save time and efforts, especially in cold and/or bad weather.

The present detailed description and the appended figures are meant to be exemplary only, and a skilled person will recognize that many changes can be made while still remaining within the proposed concept. The following paragraphs give examples of such changes but they are only a subset of all the possible changes and are presented in no particular order.

The various features of the illustrated examples can be combined different and the shapes and/or the number of the parts can be different compared to what is shown and described. The proposed concept is not limited to the illustrated examples.

Still, many other variants of the proposed concept will be apparent to a skilled person, in light of a review of the present description.

What is claimed is:

1. A front-loading trash container, the trash container including:
a container body having a front wall, a rear wall, a floor, a right side wall, a left side wall and a top section defining together an interior compartment for collecting and containing trash, the top section having a front top opening and a rear top opening;
at least one lid for each of the top openings, each lid being operatively connected to the container body;
a right and a left external sleeve member rigidly connected to right side wall and the left side wall of the container body, respectively, the right and left external sleeve members being engagable by forklift arms of a dumpster to lift and tilt the trash container until the trash therein falls by gravity through the front top opening and into the dumpster; and
a trash can dumping mechanism positioned on the rear wall of the container body, the dumping mechanism lifting and tipping a trash can to transfer trash from inside the trash can into the interior compartment of the container body through the rear top opening.

2. The system as defined in claim 1, wherein the container body is substantially rectangular in shape.

3. The system as defined in claim 1, wherein the top openings are delimited by rims that are in provided in inclined planes.

4. The system as defined in claim 3, wherein the inclined plane of the rim of the front top opening is opposite the inclined plane of the rim of the rear top opening.

5. The system as defined in claim 1, wherein the trash can dumping mechanism is positioned in a recess of the rear wall of the container body.

6. A method of handling trash using a trash container, the trash container having a front side and a rear side, the method including:
loading at least some of the trash inside the trash container using a trash can dumping mechanism positioned on the rear side of the trash container, the trash inside the trash can entering the trash container through a top opening located on the rear side of the trash container; and
emptying the trash container into a front-loading dumpster upon lifting and tipping the trash container over the dumpster until the trash falls by gravity into the dumpster through a top opening located on the front side of the trash container.
